(19) United States
(12) Patent Application Publication
(10) Pub. No.: US 2019/0304448 A1
(43) Pub. Date: Oct. 3, 2019

(54) AUDIO PLAYBACK DEVICE AND VOICE CONTROL METHOD THEREOF

(71) Applicants: BOE TECHNOLOGY GROUP CO., LTD., Beijing (CN); K-TRONICS (SUZHOU) TECHNOLOGY CO., LTD., Suzhou (CN)

(72) Inventor: Jinchao Tang, Beijing (CN)

(21) Appl. No.: 16/177,272

(22) Filed: Oct. 31, 2018

(30) Foreign Application Priority Data
Mar. 30, 2018 (CN) 201810297585.6

(51) Int. Cl. G10L 15/22; G10L 19/00; H04R 3/00

(52) U.S. Cl. CPC G10L 15/22; H04R 2430/00; H04R 3/00; G10L 19/00

(57) ABSTRACT

An audio playback device comprises: a microphone component configured to collect sound from outside and process the sound into an audio signal; a communication component configured to establish a communication connection with a separate device for communication; a memory configured to store a smart voice library containing a plurality of control command texts; and a main controller configured to perform voice recognition on the audio signal from the microphone component to generate voice text information, to perform matching between the voice text information and the plurality of control command texts in the smart voice library, and in response to the voice text information being successfully matched with one of the plurality of control command texts in the smart voice library, to execute a control command corresponding to the control command text, or control the communication component to transmit the control command to the separate device so as to control the separate device.

### CROSS-REFERENCE TO RELATED APPLICATION(S)

This application claims priority from Chinese Patent Application No. CN201810297585.6 filed on Mar. 30, 2018, the entire contents of which are hereby incorporated by reference.

### TECHNICAL FIELD

The present disclosure relates to the field of audio playback, and in particular, to an audio playback device and a voice control method thereof.

### BACKGROUND

People are increasingly feeling the convenience and comfort brought by the popularity of smart homes in today's society. Smart homes connect various devices (such as smart TVs, lighting systems, air conditioner controlling systems, security systems, network appliances, curtain controlling systems, etc.) in the home through the Internet to provide intelligent control of home appliances. Compared with conventional homes, smart homes not only have traditional residential functions, but also provide a full range of information interaction functions and achieve better control strategies.

In existing technologies, smart audio devices of smart home devices, such as smart speakers, are only used to receive control commands to realize single-channel audio playback, but cannot reflect the multifunctionality of smart home devices, thereby reducing the user experience.

It can be seen that there is a need for an improved audio playback device.

### SUMMARY

In an aspect of the disclosure, there is proposed an audio playback device comprising:

a microphone component configured to collect sound from outside and process the sound into an audio signal;

a communication component configured to establish a communication connection with other device for communication;

a memory configured to store a smart voice library containing a plurality of control command texts;

a main controller configured to:

perform voice recognition on the audio signal from the microphone component to generate voice text information;

perform matching between the voice text information and the plurality of control command texts contained in the smart voice library; and

in response to the voice text information being successfully matched with one of the plurality of control command texts in the smart voice library, execute a control command corresponding to the control command text, or control the communication component to transmit the control command to the other device so as to control the other device.

In some embodiments, the audio playback device further comprises:

a speaker component configured to receive another audio signal from the main controller, process the another audio signal into voice, and output the voice to the outside.

In some embodiments, the audio playback device further comprises:

a display component configured to receive a video signal from the main controller, process the video signal into an image, and display the image.

In some embodiments, the audio playback device further comprises:

a camera component configured to capture an image from the outside, process the image into another video signal, and provide the another video signal to the main controller.

In some embodiments, the communication component is further configured to establish a communication connection with other device through a server for communication; and

wherein the main processor is further configured to: in response to the voice text information being successfully matched with one of the plurality of control command texts contained in the smart voice library, control the communication component to transmit the control command to the server, so that the control command is transmitted to the other device by the server so as to control the other device.

In some embodiments, the main controller is further configured to receive a control command from the network through the communication component and control the audio playback device by executing the control command, or to transmit the control command to the other device so as to control the other device.

In some embodiments, the main controller is further configured to control the display component to display the voice text information generated by the voice recognition, and/or the matched control command, and/or transmission and acknowledgment processes of the control command and the execution result of the control command.

In some embodiments, a music track library containing audio features, identifications, and storage locations of a plurality of music tracks is further stored in the memory;

the main controller is further configured to:

process the audio signal from the microphone component to obtain audio feature of the audio signal;

perform matching between the audio features and audio features of the plurality of music tracks in the music library;

obtain a music track having the audio feature from the storage location of the music track in response to the matching being successful; and

control the speaker component to play the obtained music track.

In some embodiments, the main controller is further configured to:

obtain a plurality of music tracks similar in genre by performing matching between the obtained audio features and the audio features of the plurality of music tracks in the music library;

output identifications of the plurality of music tracks similar in genre through the speaker component or the display component for selection by a user; and

in response to receiving user's selection of a music track through the microphone component or the display component, obtain the music track from a storage location corresponding to the music track, and control the speaker component to play the obtained music track, and

wherein the display component is a touch screen display component.

In some embodiments, a video call application program is further stored in the memory, and the main controller is further configured to implement a video call function or a voice call function by loading and executing the video call application program.

In some embodiments, a remote sing-karaoke application program is further stored in the memory, and the main controller is further configured to implement a function of remotely singing karaoke songs by loading and executing the remote sing-karaoke application program.

In the second aspect of the disclosure, there is proposed a voice control method for an audio playback device comprising a microphone component, a speaker component, a communication component, a memory, and a main controller, the voice control method comprises:

collecting, by the microphone component, sound from outside and processing the sound into an audio signal;

performing, by the main controller, voice recognition on the audio signal from the microphone component to generate voice text information;

performing, by the main controller, matching between the voice text information and a plurality of control command texts in a smart voice library stored in the memory;

in response to the voice text information being successfully matched with one of the plurality of control command texts in the smart voice library, executing, by the main controller, a control command corresponding to the control command text, or controlling the communication component to transmit the control command to other device so as to control the other device.

In some embodiments, the voice control method further comprises:

in response to the voice text information being successfully matched with one of the plurality of control command texts in the smart voice library, controlling, by the main controller, the communication component to transmit the control command to a server, so that the control command is transmitted to the other device by the server so as to control the other device.

In some embodiments, the voice control method further comprises:

receiving, by the main controller, a control command from a network through the communication component and controlling the audio playback device by executing the control command, or transmitting the control command to the other device so as to control the other device.

In some embodiments, a music track library containing audio features, identifications, and storage locations of a plurality of music tracks is further stored in the memory, and the method further comprises:

processing, by the main controller, the audio signal from the microphone component to obtain audio feature of the audio signal;

performing, by the main controller, matching between the obtained audio features and audio features of the plurality of music tracks in the music library;

downloading, by the main controller, a music track having the obtained audio feature from a network storage location of the music track through the communication component, in response to the obtained audio feature being successfully matched with audio features of the plurality of music tracks in the smart voice library; and

controlling, by the main controller, the speaker component to play the downloaded music track.

In some embodiments, the audio playback device further comprises a display component, and the method further comprises:

displaying, by the display component, the voice text information generated by the voice recognition, and/or the matched control command, and/or transmission and acknowledgment processes of the control command and the execution result of the control command under control of the main controller.

In some embodiments, the voice control method further comprises:

obtaining, by the main controller, a plurality of music tracks similar in genre by performing matching between the obtained audio feature and the audio features of the plurality of music tracks in the music library;

outputting, by the main controller, identifications of the plurality of music tracks similar in genre through the speaker component or the display component for selection by a user;

and

in response to receiving user's selection of a music track through the microphone component or the display component, downloading, by the main controller, the music track from the Internet through the communication component, and controlling the speaker component to play the downloaded music track.

In some embodiments, a video call application program is further stored in the memory, and the method further comprises:

implementing, by the main controller, a video call function or a voice call function by executing the video call application program.

In some embodiments, a remote sing-karaoke application program is further stored in the memory, and the method further comprises:

implementing, by the main controller, a function of remotely singing karaoke songs by executing the remote sing-karaoke application program.

In some embodiments, the voice control method further comprises:

implementing, by the main controller, a function specified by an application program by storing the application program in the memory and loading and executing the stored application program.

### BRIEF DESCRIPTION OF THE DRAWINGS

FIG. 1 illustrates a schematic block diagram of an audio playback device in accordance with an embodiment of the present disclosure;

FIG. 2 illustrates a schematic control flow of an audio playback device in accordance with an embodiment of the present disclosure;

FIG. 3 illustrates a flow chart of a voice control method for an audio playback device in accordance with an embodiment of the present disclosure.

### DETAILED DESCRIPTION

In order to enable those skilled in the art to better understand the solution of the present disclosure, an audio playback device proposed by specific embodiments of the present disclosure is further described in detail below with reference to the accompanying drawings. It is apparent that the described and illustrated embodiments and the various specific features thereof, are merely illustrative of the present disclosure and are not intended to limit the disclosure. Based on the described illustrative description, all the other embodiments and specific features obtained by those of ordinary skill without any creative works are within the protection scope of the present disclosure.

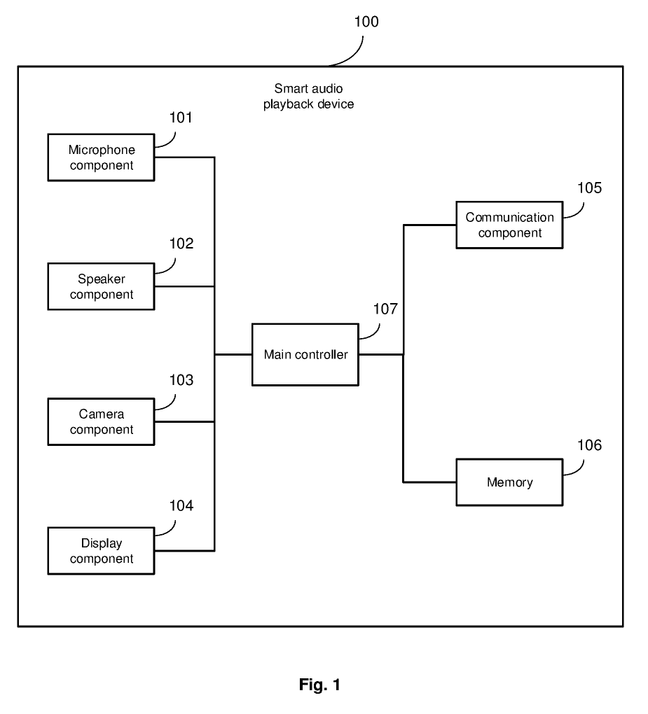

Reference is now made to FIG. 1, which illustrates a schematic block diagram of an audio playback device in accordance with an embodiment of the present disclosure. As shown in FIG. 1, the audio playback device 100 comprises a microphone component 101, a communication component 105, a memory 106, and a main controller 107.

The microphone component 101 is configured to collect sound, process the sound into an audio signal, and provide the audio signal to the main controller. The microphone component 101 may comprise one or more microphones (e.g., a microphone array comprised of multiple microphones), and related interface circuits or chips known in the art, such as audio analog-to-digital converters (ADCs), audio codecs (CODECs), digital signal processors (DSPs), etc.

The communication component 105 is configured to establish a communication connection with other devices for communication. The communication component 105 may comprise one or more wireless or wired communicators. As an example, the communication component 105 may comprise any one or more of a telecommunications communication component such as a 3G or 4G communication component, etc., a wired network communication component, a wireless local area network (WLAN) communication component, a Bluetooth communication component, and the like, so that the audio playback device 100 not only can communicate with a remote device (such as a remote server, a smart cloud, or a user mobile device) through a network, but also can communicate with a nearby device (for example, other smart home device located in the same house of an user).

The memory 106 stores a smart voice library containing a plurality of control command texts. The memory 106 may comprise a volatile storage device and/or a non-volatile storage device. As an example, the memory 106 may comprise any one or one of a random access memory (RAM), a read only memory (ROM), a memory card, a solid state hard disk, a hard disk, or an optical disk. An operating system, an application program, data, and the like may be stored in the memory 106. The operating system is used to manage and drive the hardware of the audio playback device 100, and provide services to the application program. Examples of the operating system may be a real time operating system (RTOS), a Linux operating system, an Android operating system, or the like. There may be one or any number of application programs, which may be provided by the audio playback device 100, or may be downloaded by the user through the network during the use of the audio playback device 100, or otherwise stored in the memory 106. The application program comprises a logic for implementing various functions provided by the audio playback device 100 to the user, and corresponding functions may be provided to the user by loading and executing the application program. The memory 106 also stores data used and generated by the application program, such as a smart voice library, a music library, and the like.

The main controller 107 is configured to: perform voice recognition on the audio signal from the microphone component so as to generate voice text information; perform matching between the voice text information and the plurality of control command texts in the smart voice library; and in respond to the voice text information being matched with one of the plurality of control command texts in the smart voice library, execute a control command corresponding to the control command text, or control the communication component to transmit the control command to other device so as to control the other device. The main controller 107 can be implemented by a variety of processors having logic operation and processing functions. For example, the main controller 107 can be implemented by a microprocessor (MPU), a central processing unit (CPU), or a system on chip (SOC). The main controller 107 can perform its functions by loading and executing a program stored in the memory 106.

In some embodiments, the main controller 107 can realize the voice recognition function by loading a voice recognition application program from the memory 106 and executing the same. In other embodiments, the main controller 107 may comprise an associated voice recognition chip, with which the voice recognition function can be realized.

The smart voice library stored in the memory 106 may comprise a plurality of control commands and voice text information corresponding thereto, for example, control commands for controlling the function of the audio playback device itself (e.g., control commands for adjusting speaker volume, turning on or off the display, or searching for information from the network, etc.) and voice text information corresponding thereto, as well as control commands for controlling other smart home devices (e.g., control commands for controlling, for example, on/off, volume, channel, wind speed, temperature, recording etc. of other smart home devices such as a smart TV, air conditioner, refrigerator, camera, etc.) and voice text information corresponding thereto. In this way, the main controller 107 can firstly perform voice recognition on the audio signal from the microphone component to generate voice text information, and then perform matching between the voice text information and the plurality of control commands in the smart voice library so as to find a corresponding control command, and finally execute the control command or transmit it to other smart home devices to control other smart home devices.

In this way, the audio playback device 100 not only has the function of traditional audio playback devices such as playing music, etc., but also becomes the control center of the entire smart home realizing the voice control of respective smart home devices in the entire smart home.

In some embodiments, the audio playback device 100 may also comprise a speaker component 102. The speaker component 102 may comprise one or more speakers, as well as related interface circuits or chips known in the art, such as audio digital to analog converters, audio codecs, digital signal processors, and the like.

In some embodiments, the audio playback device 100 may also comprise a display component 104. The display component 104 may comprise a display, as well as related interface circuits or chips known in the art, such as video digital to analog converters, video codecs, digital signal processors (DSPs), and the like. In some embodiments, the display component 104 is a touch screen display component such that the display component 104 can function as both a display output device and a touch feedback or input device.

In some embodiments, the audio playback device 100 may also comprise a camera component 103 configured to capture images from outside, process the images into video signals, and provide the video signals to the main controller 107.

The camera component 103 may comprise one or more cameras, as well as related interface circuits or chips known in the art, such as video analog to digital converters, video codecs, digital signal processors, and the like.

In some embodiments, the communication component 105 is further configured to establish a communication connection with other devices through a server for communication. The main controller 107 is further configured to: in response to the voice text information being matched with one of the plurality of control command texts in the smart voice library, control the communication component 105 to transmit the corresponding control command matched with the voice text information to the server, so that the control command may be transmitted to the other devices by the server so as to control the other devices.

The server may, for example, be located on the Internet, set up and maintained by one or more manufacturers or other organizations of the audio playback device 100 and other smart devices, and have information such as device identifier, device type, and network address, etc., of each of the audio playback device 100 and other smart devices stored thereon. In some embodiments, the server may also store other information, such as a music library or the like as discussed below. The server may also be referred to as a smart cloud. In such an embodiment, the control command transmitted to the server comprises the identifier of the other smart device for which the control command is directed, so that the server can query information, such as the network address etc., of the other smart device by using the identifier. Thus, the control command can be forwarded to the other smart device over the network. In this way, by means of the audio playback device 100, not only voice control for other smart devices in the vicinity of the audio playback device 100 (for example, located in the same local area network) but also voice control for other remote smart devices can be realized.

In some embodiments, the main controller 107 is further configured to receive a control command from the network through the communication component 105 and control the audio playback device 100 by executing the control command, or to transmit the control command to the other device so as to control the other device. The control command from the network may be, for example, a control command transmitted by the user via its mobile device (e.g., a smart phone), which may be, for example, a control command that the user's mobile device recognizes from voice instruction of the user by using the voice recognition function, or a control command that the user inputs through an input method, such as text or touching inputting, and transmits. The control command may be a control command of the user for the audio playback device 100, or may be a control common for other smart devices in the vicinity of the audio playback device 100. The control command can be directly transmitted by the user's mobile device to the audio playback device 100, for example, over a telecommunications network and/or the Internet, or the control command may be transmitted by the user's mobile device to the server (e.g., a smart cloud) over the telecommunications network and/or the Internet and then transmitted by the server to the audio playback device 100 over the Internet.

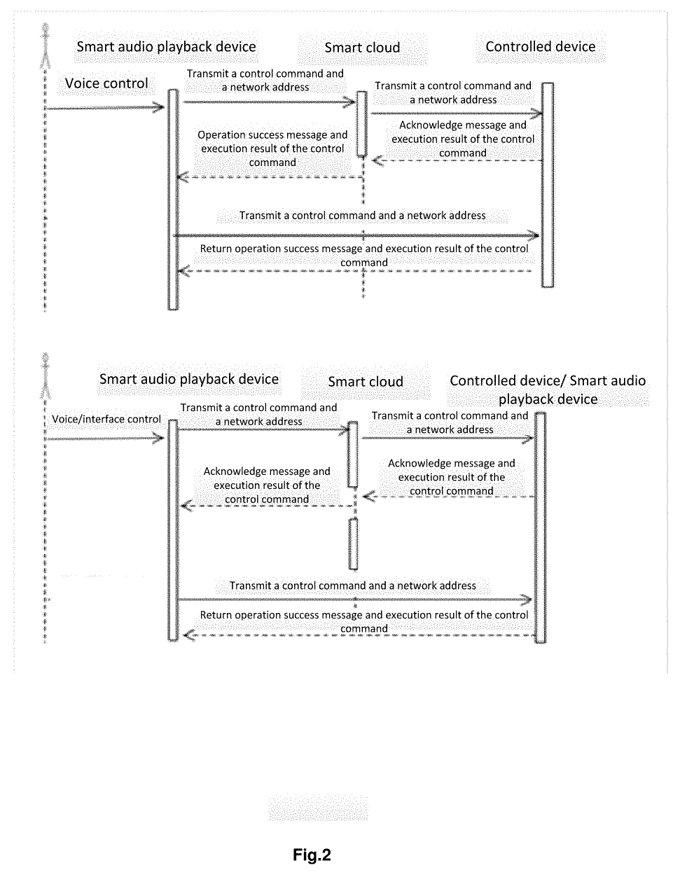

FIG. 2 illustrates a schematic control flow of an audio playback device 100 in accordance with an embodiment of the present disclosure, wherein the flow of the upper portion of FIG. 2 illustrates a scenario in which a user utilizes the audio playback device 100 to control other devices, and the flow of the lower portion of FIG. 2 illustrates a scenario in which a user utilizes a smart phone to control the audio playback device 100 and other devices.

As shown in the flow of the upper portion of FIG. 2, upon a user issuing a voice command for a controlled device to an audio playback device 100, the audio playback device 100 receives the voice command, performs voice recognition thereon to obtain a corresponding control command and the network address (e.g., URL) of the controlled device for which the control command is directed, and then transmits the control command and the obtained network address to a smart cloud. The smart cloud transmits the received control command and network address to a corresponding controlled device. The controlled device returns an acknowledgement message and an execution result of the control command to the smart cloud. The smart cloud returns an operation success message and the execution result of the control command to the audio playback device. Alternatively, upon a user issuing a voice command for a controlled device to the audio playback device 100, the audio playback device 100 receives the voice command, and performs voice recognition thereon to obtain a corresponding control command and the network address (e.g., URL) of the controlled device for which the control command is directed, and then directly transmits the control command and the obtained network address to the corresponding controlled device. The controlled device returns an operation success message and an execution result of the control command to the audio playback device 100.

As described in the flow of the lower portion of FIG. 2, upon a user issuing a voice/interface command for the audio playback device 100 or a controlled device to his or her smartphone, the smartphone receives the voice/interface command, generates a corresponding control command and the network address (e.g., URL) of the controlled device or the audio playback device 100 for which the control command is directed, and then transmits the control command and the network address to a smart cloud. The smart cloud transmits the received control command and network address to the corresponding controlled device or the audio playback device 100. The controlled device or audio playback device 100 returns an acknowledgement message and an execution result of the control command to the smart cloud. The smart cloud returns an acknowledgment message and details of the execution of the control command to the smartphone. Alternatively, upon a user issuing a voice/interface command for the audio playback device 100 or a controlled device to a smartphone, the smartphone receives the voice/interface command, generates a corresponding control command and the network address (e.g., a URL) of the controlled device or the audio playback device 100 for which the control command is directed, and then directly transmits the control command and the network address to the corresponding controlled device or the audio playback device 100. The controlled device or the audio playback device 100 returns an operation success message and an execution result of the control command.

In some embodiments, the main controller 107 is further configured to control the display component 104 to display the voice text information generated by voice recognition, and/or the matched control command, and/or transmission and acknowledgment processes of the control command and the execution result thereof. In this way, by means of the visual interaction provided by the display component 104, the convenience of the voice interaction via the audio playback device 100 is advantageously improved, the intuitiveness and accuracy of the information feedback are improved, and other functions besides the voice interaction are extended, enabling the audio playback device to better integrate into the user's home life.

In some embodiments, the memory 106 also stores a music library containing audio features, identifications, and storage addresses of a plurality of music tracks. The main controller 107 is also configured to:

process an audio signal from the microphone component 101 to obtain audio feature of the audio signal;

perform matching between the audio feature and audio features of the plurality of music tracks in the music library;

obtain a music track having audio feature from a storage address of the music track, in response to the matching being successful;

control the speaker component 102 to play the obtained music track.

The audio feature of the music track may be, for example, a frequency distribution feature of the music track obtained by Fourier Transform of the music track. The frequency distribution feature of each music track is usually unique and can therefore be used to identify the music track. The identification of the music track may be, for example, a title of the music track or the like. The storage address of the music track may be, for example, a local storage address of the music track in the music library, or a storage address of the music track in the server, or a network storage address of the music track.

In these embodiments, the microphone component 101 can collect a music track played by other device and process it to an audio signal; and the main processor 107 can download and play the corresponding music track by processing the audio signal and performing a matching procedure. As such, the audio playback device 100 has a function of identifying a music track upon listening to the same. The main controller 107 can obtain audio feature of the audio signal and perform matching between the obtained audio feature and the audio features of the music track in the music library utilizing any method known in the art.

In some embodiments, the main controller 107 can load a music application program from the memory 106 and execute it, and display a graphical user interface of the music application program on the display component 104. The graphical user interface can list music tracks contained in the music library, among which a music track may be selected by a user for playing. The graphical user interface may also comprise a button for track identification function, which can be enabled when touched by a user. The music application program can be a music application program known in the art or an application program similar to a music application program known in the art.

In some embodiments, the main controller 107 is further configured to:

obtain a plurality of music tracks similar in genre by performing matching between the obtained audio feature and the audio features of the plurality of music tracks in the music library;

output identifications of the plurality of music tracks similar in genre via the speaker component 102 or the display component 104 for user selection;

obtain a music track from the storage location of the music track in response to receiving the user's selection of the music track through the microphone component 101 or the display component 104, and control the speaker component 102 to play the obtained music track, wherein the display component 104 is a touch screen display component.

As such, the audio playback device 100 has a function of searching for similar music tracks. The main controller 107 can perform matching between the obtained audio feature and the audio features of the music tracks in the music library utilizing any method known in the art, so as to obtain music tracks similar in genre.

In some embodiments, the main controller 107 can load a music application program from the memory 106 and execute the same, and display a graphical user interface of the music application program on the display component 104. The graphical user interface may comprise a button for similar tracks searching function, which can be enabled when touched by a user.

In some embodiments, a video call application program is also stored in the memory 106, and the main controller 107 is further configured to load and execute the video call application program and realize a video call function or a voice call function by means of the microphone component 101, the speaker component 102, the camera component 103, the display component 104, and the communication component 105. The video call application program can be a video call application program known in the art or an application program similar to a video call application program known in the art. During a video call or a voice call, the main controller 107 can obtain the user's voice information in real time via the microphone component 101, obtain the user's video information in real time via the camera component 103, and transmit the user's voice information and the user's video information to the user interface of the video call application program of the other calling party through the communication component 105; at the same time, the main controller 107 can receive voice information and video information from the video call application program of the other calling party through the communication component 105, and output the voice information via the speaker component 105 and display the video information via the display component 104. In this way, the user can conveniently perform video chat or voice chat utilizing the video call function or the voice call function of the audio playback device 100.

In some embodiments, a remote sing-karaoke application program is also stored in the memory 106, and the main controller 107 is further configured to load and execute the remote sing-karaoke application program and realize a function of remotely singing karaoke songs by means of the microphone component 101, the speaker component 102, the camera component 103, the display component 104, and the communication component 106. The remote sing-karaoke application program can be a remote sing-karaoke application program known in the art or an application program similar to a remote sing-karaoke application program known in the art. During the process of remotely singing karaoke songs, the main controller 107 can obtain the user's voice information via the microphone component 101 in real time, obtain the user's video information via the camera component 103 in real time, and transmit, via the communication component 105, the user's voice information and video information to a remote sing-karaoke platform on a smart cloud for sharing by all users who log in to the remote sing-karaoke platform; at the same time, the main controller 107 can receive, via the communication component 105, voice information and video information of other users on the remote sing-karaoke platform, and output the voice information via the speaker component 102 and display the video information via the display component 104. In this way, a user can conveniently sing karaoke songs in a remote fashion utilizing the remote sing-karaoke function of the audio playback device 100.

In some embodiments, the main controller 107 is further configured to implement a function specified by an application program by storing the application program in the memory 106 and loading and executing the stored application program. For example, the application program may be downloaded from the network via the communication component 105, or downloaded from other storage devices via a local interface (e.g., a USB interface) provided in the audio playback device 100. Therefore, the audio playback device 100 can obtain different functions by downloading and storing different application programs, thereby having unlimited function extensibility.

The audio playback device 100 according to an embodiment of the present disclosure has been described above with reference to the accompanying drawings. It is to be noted that the above illustration and description are only examples, and are not intended to limit the disclosure. In other embodiments disclosed, the audio playback device 100 may have more, fewer, or different components, and positional relationship, connection relationship, and functional relationship between various components may differ from those described and illustrated. For example, the audio playback device 100 may also comprise various operation buttons and interfaces such as an audio playback device on/off button, a volume adjustment button, a camera on/off button, a power interface, a USB interface, and the like. Moreover, various components of the audio playback device 100 can generally be implemented in hardware, software, or any combination thereof. The function of one component may also be accomplished by other component. In addition, it should be noted that the names of various components in the present application are merely for convenience of description, and are not intended to limit the present disclosure.

As will be apparent to those skilled in the art from reading the above description, in another aspect of the present disclosure, there is also proposed a voice control method employing an audio playback device in accordance with any one of the embodiments of the present disclosure. In other words, the voice control method can be performed by the above-described audio playback device 100 in accordance with an embodiment of the present disclosure, and thus the voice control method of the audio playback device can correspond to operations of various components of the audio playback device 100 in accordance with an embodiment of the present disclosure. For the sake of brevity, some of the details repeated with the above description are omitted in the following description. Thus, a more detailed understanding of the voice control method of the audio playback device in accordance with an embodiment of the present disclosure can be obtained with reference to the above description.

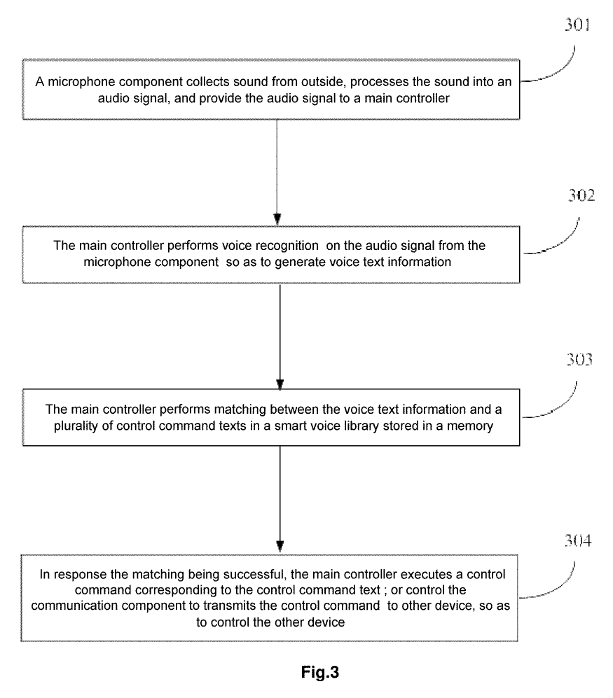

FIG. 3 illustrates a voice control method for an audio playback device comprising a microphone component, a speaker component, a camera component, a display component, a communication component, a memory, and a main controller, in accordance with an embodiment of the present disclosure. As shown in FIG. 3, the method comprises steps 301-304, in which:

At step 301, sound from outside is collected, processed into an audio signal, and the audio signal is provided to a main controller, by a microphone component;

At step 302, voice recognition is performed on the audio signal from the microphone component by the main controller so as to generate voice text information;

At step 303, matching between the voice text information and a plurality of control command texts in a smart voice library stored in a memory is performed by the main controller;

At step 304, in response to the voice text information being successfully matched with one of the plurality of control command texts in the smart voice library, a control command corresponding to the control command text is executed by the main controller; or the control command is transmitted, by the communication component, to other device so as to control the other device.

In some embodiments, the method further comprises the step of:

in response to the voice text information being successfully matched with one of the plurality of control command texts in the smart voice library, the main controller controlling the communication component to transmit the control command corresponding to the control command text to a server, so that the control command is transmitted, by the server, to the other device so as to control the other device.

In some embodiments, the method further comprises the step of:

the main controller receiving a control command from the network through the communication component, and controlling the audio playback device by executing the control command, or transmitting the control command to the other device so as to control the other device.

In some embodiments, the method further comprises the step of:

the display component displaying the voice text information generated by voice recognition, and/or the matched control command, and/or transmission and acknowledgment processes of the control command and the execution result thereof under control of the main controller.

In some embodiments, a music library containing audio features of a plurality of music tracks and network download address thereof is also stored in the memory, and the method further comprises the steps of:

the main controller processing the audio signal from the microphone component to obtain audio feature of the audio signal;

the main controller performing matching between the obtained audio feature and audio features of a plurality of music tracks in the music library;

in response to the matching being successful, the main controller downloading a music track having the music feature from the network download address of the music track through the communication component;

the main controller controlling the speaker component to play the downloaded music track.

In some embodiments, the method further comprises the steps of:

the main controller obtaining a plurality of music tracks similar in genre by performing matching between the obtained audio feature and audio features of a plurality of music tracks in the music library;

the main controller outputting identifications of the plurality of music tracks similar in genre via the speaker component or the display component for user selection;

in response to receiving the user's selection of a music track through the microphone component or the display component, the main controller downloading the music track from the Internet through the communication component, and controlling the speaker component to play the downloaded music track, wherein the display component is a touch screen display component.

In some embodiments, a video call application program is also stored in the memory, and the method further comprises the step of:

the main controller implementing a video call function and a voice call function by executing the video call application program utilizing the microphone component, the speaker component, the camera component, the display component, and the communication component.

In some embodiments, a remote sing-karaoke application program is also stored in the memory, and the method further comprises the step of:

the main controller implementing a remote sing-karaoke function by executing the remote sing-karaoke application program utilizing the microphone component, the speaker component, the camera component, the display component, and the communication component.

In some embodiments, the method further comprises the step of:

the main controller implementing functions specified by application programs by storing the application programs in the memory and loading and executing the stored application programs.

A control method for an audio playback device according to an embodiment of the present disclosure has been described above with reference to the accompanying drawings. It should be noted that the above illustration and description are only examples, and are not intended to limit the present disclosure. In other embodiments disclosed, the control method of the audio playback device may have more, fewer, or different steps, and sequence relationship, including relationship, and functional relationship between various components may be different from those described and illustrated. For example, generally multiple steps may be combined into one step, and one step may also be divided into multiple steps, and some steps may be performed in any order or in parallel.

The foregoing description of embodiments of the present invention has been provided for the purpose of illustration and description. Numerous specific details, such as examples of specific components and apparatuses, are set forth in the foregoing description to provide a thorough understanding of embodiments of the present disclosure. However, it is not intended to be exhaustive or to limit the disclosure. Various elements or features of a particular embodiment are generally not limited to the particular embodiment, but are interchangeable where applicable and may be used in other embodiments, even if not specifically illustrated or described. Such variations are not to be regarded as a departure from the disclosure, and all such modifications are intended to be comprised within the scope of the disclosure. In some example embodiments, well-known components, structures, and techniques are not described in detail.

Terms used herein are merely for the purpose of describing particular example embodiments and are not intended to be limiting. As used herein, the singular form such as “a”, “an” or “the” is also intended to include the plural form, unless the context clearly states otherwise. The terms “include”, “including”, “comprise” and “have” are inclusive, and thus indicate the existence of the described feature, entity, step, operation, element and/or component, but not exclude the presence or addition of one or more other features, entities, steps, operations, elements, components and/or combinations thereof. The steps, processes, and operations described herein are not to be construed as necessarily requiring that they shall be executed in the specific order discussed or illustrated, unless explicitly identified as the order of execution.

When an element or layer is referred to as being “on,” “attached to,” “connected to,” or “coupled to” another element or layer, the element or layer may be directly on the another element or layer, or directly attached, connected or coupled to the another element or layer, or an intervening element or layer may exist therebetween. Other terms used to describe the relationship between the elements, for example, “between” and “directly between”, “adjacent” and “directly adjacent”, etc., should be interpreted in a similar manner. As used herein, “connect”, “link”, or similar terms, when not otherwise specifically defined, may refer to any one or more of mechanical, electrical, and communication connections. Also, as used herein, the term “and/or” comprises any and all combinations of one or more of the associated listed items.

Although the terms “first”, “second”, “third”, etc. may be used herein to describe various elements, components, layers and/or parts, these elements, components, layers and/or parts should not be limited to these terms. These terms are only used to distinguish one element, component, layer and/or part from another element, component, layer and/or part. Terms such as “first,” “second,” and other numerical terms when used herein do not mean the order or sequence, unless otherwise explicitly stated in the context. Thus, a first element, component, layer or part in present application may be referred to as a second element, component, layer or part, without departing from the teachings of the example embodiments.

For the convenience of description, spatially related terms such as “internal,” “external,” “below,” “under,” “above,” “over,” etc., may be used herein to describe the relationship between one element or feature and another element or feature as illustrated in the figures. Spatially relative terms may be intended to encompass different orientations of the device in use or operation, in addition to the orientation shown in the figures. For example, if a device in the figures is turned over, the elements that are described as “below” or “under” other elements or features will be oriented “above” the other elements or features. Thus, the exemplary term “below” can encompass the orientations above and below. The apparatus may be otherwise oriented (rotated 90 degrees or in other directions), and the spatial descriptions used herein accordingly should be interpreted relatively.

It is to be understood that the above-described embodiments of the present disclosure are merely exemplary embodiments employed to explain the principles of the present disclosure, and the present disclosure is not limited thereto. Various modifications and improvements can be made by those skilled in the art without departing from the spirit and scope of the disclosure, and such modifications and improvements are also considered to be within the scope of the present disclosure. The scope of the present disclosure is to be limited only by the meaning of the language of the appended claims and their equivalents.

I/We claim:

1. An audio playback device comprising:
a microphone component configured to collect sound from outside and process the sound into an audio signal;
a communication component configured to establish a communication connection with a separate device for communication;
a memory configured to store a smart voice library containing a plurality of control command texts; and
a main controller configured to:
perform voice recognition on the audio signal from the microphone component to generate voice text information;
perform matching between the voice text information and the plurality of control command texts contained in the smart voice library; and
in response to the voice text information being successfully matched with one of the plurality of control command texts in the smart voice library, execute a control command corresponding to the control command text, or control the communication component to transmit the control command to the other device so as to control the separate device.

2. The audio playback device of claim 1, further comprising:
a speaker component configured to receive a further audio signal from the main controller, process the further audio signal into voice, and output the voice to the outside.

3. The audio playback device of claim 1, further comprising:
a display component configured to receive a video signal from the main controller, process the video signal into an image, and display the image.

4. The audio playback device of claim 1, further comprising:
a camera component configured to capture an image from the outside, process the image into a video signal, and provide the video signal to the main controller.

5. The audio playback device of claim 1, wherein the communication component is further configured to establish a communication connection with the separate device through a server for communication; and
wherein the main processor is further configured to: in response to the voice text information being successfully matched with one of the plurality of control command texts contained in the smart voice library, control the communication component to transmit the control command to the server, so that the control command is transmitted to the separate device by the server so as to control the separate device.

6. The audio playback device of claim 1, wherein the main controller is further configured to receive control commands from the network through the communication component and control the audio playback device by executing the control commands, or to transmit the control commands to the separate device so as to control the separate device.

7. The audio playback device of claim 3, wherein the main controller is further configured to control the display component to display the voice text information generated by the voice recognition, and/or the matched control command, and/or transmission and acknowledgment processes of the control command and the execution result of the control command.

8. The audio playback device of claim 2, wherein a music track library containing audio features, identifications, and storage locations of a plurality of music tracks is further stored in the memory, and the main controller is further configured to:
process the audio signal from the microphone component to obtain an audio feature of the audio signal;
perform matching between the audio feature and audio features of the plurality of music tracks in the music library;
obtain a music track having the audio feature from the storage location of the music track in response to the matching being successful; and
control the speaker component to play the obtained music track.

9. The audio playback device of claim 8, wherein the main controller is further configured to:
obtain a plurality of music tracks similar in genre by performing matching between the obtained audio feature and the audio features of the plurality of music tracks in the music library;
output identifications of the plurality of music tracks similar in genre through the speaker component or a display component for selection by a user; and
in response to receiving user's selection of a music track through the microphone component or the display component, obtain the music track from a storage location corresponding to the music track, and control the speaker component to play the obtained music track, and
wherein the display component is a touch screen display component.

10. The audio playback device of claim 1, wherein a video call application program is further stored in the memory, and the main controller is further configured to implement a video call function or a voice call function by loading and executing the video call application program.

11. The audio playback device of claim 1, wherein a remote sing-karaoke application program is further stored in the memory, and the main controller is further configured to implement a function of remotely singing karaoke songs by loading and executing the remote sing-karaoke application program.

12. A voice control method for an audio playback device comprising a microphone component, a speaker component, a communication component, a memory, and a main controller, the voice control method comprising:
collecting, by the microphone component, sound from outside and processing the sound into an audio signal;
performing, by the main controller, voice recognition on the audio signal from the microphone component to generate voice text information;
performing, by the main controller, matching between the voice text information and a plurality of control command texts contained in a smart voice library stored in the memory; and
in response to the voice text information being successfully matched with one of the plurality of control command texts in the smart voice library, executing, by the main controller, a control command corresponding to the control command text, or controlling, by the main controller, the communication component to transmit the control command to a separate device so as to control the separate device.

13. The voice control method of claim 12, further comprising:
in response to the voice text information being successfully matched with one of the plurality of control command texts in the smart voice library, controlling, by the main controller, the communication component to transmit the control command to a server, so that the control command is transmitted to the separate device by the server so as to control the separate device.

14. The voice control method of claim 12, further comprising:
receiving, by the main controller, control commands from a network through the communication component and controlling the audio playback device by executing the control commands, or transmitting the control commands to the separate device so as to control the other device.

15. The voice control method of claim 12, wherein a music track library containing audio features, identifications, and storage locations of a plurality of music tracks is further stored in the memory, and the method further comprises:
processing, by the main controller, the audio signal from the microphone component to obtain audio feature of the audio signal;
performing, by the main controller, matching between the obtained audio feature and audio features of the plurality of music tracks in the music library;
downloading, by the main controller, a music track having the obtained audio feature from network storage location of the music track through the communication component, in response to the obtained audio feature being successfully matched with audio features of the plurality of music tracks in the smart voice library; and
controlling, by the main controller, the speaker component to play the downloaded music track.

16. The voice control method of claim 12, wherein the audio playback device further comprises a display component, and the method further comprises:
displaying, by the display component, the voice text information generated by the voice recognition, and/or the matched control command, and/or transmission and acknowledgment processes of the control command and the execution result of the control command under control of the main controller.

17. The voice control method of claim 15, further comprising:
obtaining, by the main controller, a plurality of music tracks similar in genre by performing matching between the obtained audio feature and the audio features of the plurality of music tracks in the music library;
outputting, by the main controller, identifications of the plurality of music tracks similar in genre through the speaker component or a display component for selection by a user; and
in response to receiving user's selection of a music track through the microphone component or the display component, downloading, by the main controller, the music track from the Internet through the communication component, and controlling the speaker component to play the downloaded music track.

18. The voice control method of claim 12, wherein a video call application program is further stored in the memory, and the method further comprises:
implementing, by the main controller, a video call function or a voice call function by executing the video call application program.

19. The voice control method of claim 12, wherein a remote sing-karaoke application program is further stored in the memory, and the method further comprises:
implementing, by the main controller, a function of remotely singing karaoke songs by executing the remote sing-karaoke application program.

20. The voice control method of claim 12, further comprising:
implementing, by the main controller, a function specified by an application program by storing the application program in the memory and loading and executing the stored application program.
